(19) United States
(12) Patent Application Publication
(10) Pub. No.: US 2024/0284527 A1
(43) Pub. Date: Aug. 22, 2024

(54) CONNECTION ESTABLISHMENT AND DATA TRANSMISSION METHODS AND APPARATUSES, AND COMMUNICATION DEVICE

(71) Applicant: GUANGDONG OPPO MOBILE TELECOMMUNICATIONS CORP., LTD., Dongguan (CN)

(72) Inventor: Yang XU, Dongguan (CN)

(73) Assignee: GUANGDONG OPPO MOBILE TELECOMMUNICATIONS CORP., LTD., Dongguan (CN)

(21) Appl. No.: 18/650,383

(22) Filed: Apr. 30, 2024

Related U.S. Application Data
(63) Continuation of application No. PCT/CN2021/128454, filed on Nov. 3, 2021.

(51) Int. Cl. H04W 76/10; H04W 12/043; H04W 12/106

(52) U.S. Cl. CPC H04W 76/10; H04W 12/043; H04W 12/106

(57) ABSTRACT

Embodiments of the present application provide connection establishment and data transmission methods and apparatuses, and a communication device. The connection establishment method includes that: a mobile network control plane node receives a first request message from a terminal; the mobile network control plane node sends to at least one node a second request message used for request for establishment of a first connection between the at least one node and the terminal, and data transmitted on the first connection is processed by a data processor of at least one of the at least one node and/or the terminal.

### CROSS-REFERENCE TO RELATED APPLICATION

This application is a continuation application of International Patent Application No. PCT/CN2021/128454 filed on Nov. 3, 2021, the content of which is incorporated herein by reference in its entirety.

### TECHNICAL FIELD

Embodiments of the disclosure relate to the field of mobile communication technology, and particularly to methods and apparatuses for establishing a connection and transmitting data, and a communication device.

### BACKGROUND

At present, the manner of data transmission in a network is just data propagation, and the data propagation refers to transmitting data from node A to node B. Such a data transmission manner is inefficient mainly in two aspects as follows: in one aspect, the amount of data transmitted in the network may increase significantly with explosive increase in the amount of data, increasingly overburdening the network; and in the other aspect, a growing amount of data are received by a receiving end which has to process a growing amount of data accordingly, thus the risk of overburdening the receiving end is increased.

### SUMMARY

Embodiments of the disclosure provide methods and apparatuses for establishing a connection and transmitting data, a communication device, a chip, a computer-readable storage medium, a computer program product, and a computer program.

A method for establishing a connection according to embodiments of the disclosure includes operations as follows.

A mobile network control plane node receives a first request message from a terminal.

The mobile network control plane node sends a second request message to at least one node, the second request message being configured to request for establishment of a first connection between the at least one node and the terminal. Data transmitted on the first connection are processed by a data processor of at least one of the at least one node or the terminal.

A method for establishing a connection according to embodiments of the disclosure includes operations as follows.

A terminal sends a first request message to a mobile network control plane node. The first request message is configured to trigger the mobile network control plane node to send a second request message to at least one node, the second request message being configured to request for establishment of a first connection between the at least one node and the terminal. Data transmitted on the first connection are processed by a data processor of at least one of the at least one node or the terminal.

A method for transmitting data according to embodiments of the disclosure includes operations as follows.

A data processor of a first node receives first data, and processes the first data to obtain second data.

The first node sends the second data to a second node.

An apparatus for establishing a connection according to embodiments of the disclosure applies to a mobile network control plane node. The apparatus includes a receiving unit and a sending unit.

The receiving unit is configured to receive a first request message from a terminal.

The sending unit is configured to send a second request message to at least one node, the second request message being configured to request for establishment of a first connection between the at least one node and the terminal. Data transmitted on the first connection are processed by a data processor of at least one of the at least one node or the terminal.

An apparatus for establishing a connection according to embodiments of the disclosure applies to a terminal. The apparatus includes a sending unit.

The sending unit is configured to send a first request message to a mobile network control plane node. The first request message is configured to trigger the mobile network control plane node to send a second request message to at least one node, request for establishment of a first connection between the at least one node and the terminal. Data transmitted on the first connection are processed by a data processor of at least one of the at least one node or the terminal.

An apparatus for transmitting data according to embodiments of the disclosure applies to a first node having a data processor. The apparatus includes a receiving unit, a processing unit, and a sending unit.

The receiving unit is configured to receive first data.

The processing unit is configured to process the first data through the data processor to obtain second data.

The sending unit is configured to send the second data to a second node.

A communication device according to embodiments of the disclosure includes a processor and a memory. The memory is configured to store a computer program. The processor is configured to call and run the computer program stored in the memory to perform a foregoing method.

A chip according to embodiments of the disclosure is configured to implement a foregoing method.

Specifically, the chip includes a processor configured to call and run a computer program in a memory, causing a device installed with the chip to perform a foregoing method.

A computer-readable storage medium according to embodiments of the disclosure has stored thereon a computer program. The computer program causes a computer to perform a foregoing method.

A computer program product according to embodiments of the disclosure includes computer program instructions. The computer program instructions cause a computer to perform a foregoing method.

A computer program according to embodiments of the disclosure causes a computer to perform a foregoing method when the computer program is run on the computer.

With the technical solution, during data transmission, one or more nodes in a mobile network process data through a data processor of the one or more nodes, and send a data processing result to a next node, reducing the pressure of network caused by the excessive amount of transmitted data, and relieving a data processing burden on the data receiving end.

### BRIEF DESCRIPTION OF THE DRAWINGS

Drawings illustrated here are provided for further understanding of the disclosure, and form a part of the disclosure. Illustrative embodiments of the disclosure and the descriptions thereof are for explaining the disclosure, and do not form improper limitations to the disclosure.

FIG. 1 is a diagram of a scene in which embodiments of the disclosure are applied.

FIG. 2A is a diagram where a mobile network serves as a pipeline for transmitting application data.

FIG. 2B is a diagram where a mobile network processes application data and sends a data processing result to an application server.

FIG. 3 is a flowchart of a method for transmitting data according to embodiments of the disclosure.

FIG. 4 is a diagram of locations of a data processor according to embodiments of the disclosure.

FIG. 5 is a diagram of locations of a data processing layer according to embodiments of the disclosure.

FIG. 6 is a diagram of model partitioning according to embodiments of the disclosure.

FIG. 7 is flowchart 1 of a method for establishing a connection according to embodiments of the disclosure.

FIG. 8 is flowchart 2 of the method for establishing a connection according to embodiments of the disclosure.

FIG. 9 is a diagram of a structural composition of an apparatus for transmitting data according to embodiments of the disclosure.

FIG. 10 is diagram 1 of a structural composition of an apparatus for establishing a connection according to embodiments of the disclosure.

FIG. 11 is diagram 2 of the structural composition of the apparatus for establishing a connection according to embodiments of the disclosure.

FIG. 12 is a diagram of a structure of a communication device according to embodiments of the disclosure.

FIG. 13 is a diagram of a structure of a chip according to embodiments of the disclosure.

FIG. 14 is a block diagram of a communication system according to embodiments of the disclosure.

### DETAILED DESCRIPTION

A technical solution in embodiments of the disclosure is hereinafter with reference to the drawings of the embodiments of the disclosure. The embodiments herein are some, instead of all, embodiments of the disclosure. Based on the embodiments of the disclosure, a person having ordinary skill in the art may acquire another embodiment without creative effort, and any such embodiment falls within the scope of the disclosure.

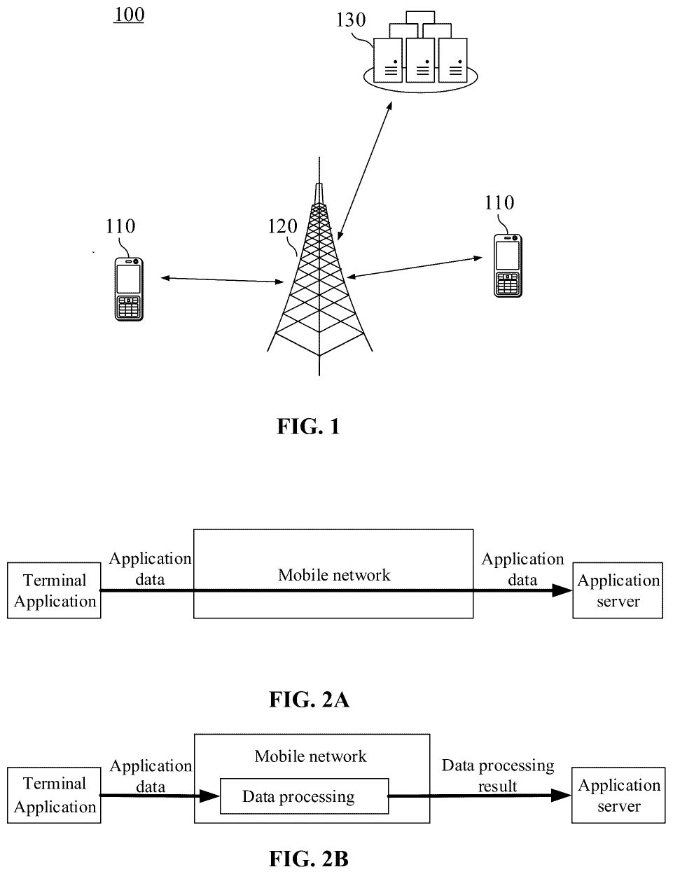

FIG. 1 is a diagram of a scene in which embodiments of the disclosure are applied.

As illustrated in FIG. 1, the communication system 100 may include terminals 110 and a network device 120. The network device 120 may communicate with a terminal 110 through an air interface. Multi-service transmission between a terminal 110 and the network device 120 is supported.

Note that embodiments of the disclosure are illustrated taking the communication system 100 as an example. However, embodiments of the disclosure are not limited to the communication system. That is, the technical solution according to embodiments of the disclosure may apply to various communication systems, such as a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5th generation (5G) communication system (also referred to as a new radio NR communication system), or a future communication system, etc.

In the communication system 100 illustrated in FIG. 1, the network device 120 may be an access network device communicating with a terminal 110. The access network device may provide a specific geographical region with a communication coverage, and may communicate with a terminal 110 (such as a UE) located in the covered region.

The network device 120 may be a base station (BS) (an evolutional node B, eNodeB or eNB) in a long term evolution (LTE) system, or a next generation radio access network (NG RAN) device, or a base station (next generation NodeB, gNB) in a NR system, or a radio controller in a cloud radio access network (CRAN). Alternatively, the network device 120 may be a relay station, an access point, an onboard device, a wearable device, a hub, a switch, a bridge, a router, or a network device in a future evolved public land mobile network (PLMN), etc.

A terminal 110 may be any terminal, including but not limited to one connected to the network device 120 or another terminal through a wired or wireless connection.

For example, the terminal 110 refers to an access terminal, a user equipment (UE), a user unit, a user station, a mobile station, a remote station, a remote terminal, a mobile device, a user terminal, a terminal, a wireless communication device, a user agent, or a user apparatus, etc. The access terminal may be a cell phone, a cordless phone, a session initiation protocol (SIP) phone, an IoT device, a handheld satellite terminal, a wireless local loop (WLL) station, a personal digital assistant (PDA), a handheld device capable of radio communication, a computing device, or another processing device connected to a radio modem, an onboard device, a wearable device, a terminal in a 5G network, or a terminal in a future evolved network, etc.

A terminal 110 may be configured for device to device (D2D) communication.

The radio communication system 100 may further include a core device 130 in communication with a base station. The core device 130 may be a 5G core (5GC) device, such as an access and mobility management function (AMF), an authentication server function (AUSF), a user plane function (UPF), a session management function (SMF), etc. In an implementation, the core device 130 may also be an evolved packet core (EPC) device of a LTE network, such as a session management function+core packet gateway (SMF+PGW-C) device. Note that the SMF+PGW-C device may implement functions of both SMF and PGW-C. During network evolution, the core device may also be referred to by another name, or form new network entities by core function division, which is not limited in embodiments of the disclosure.

A connection may be established to implement communication between functional units in the communication system 100 through a next generation (NG) network interface.

For example, a terminal may establish, through an NR interface, an air interface connection to an access network device to transmit user plane data and control plane signalling. The terminal may establish a control plane signalling connection to an AMF through an NG interface 1 (N1). The access network device, such as a next generation radio access NodeB (gNB), may establish a user plane data connection to a UPF through an NG interface 3 (N3). The access network device may establish a control plane signalling connection to the AMF through an NG interface 2 (N2). The UPF may establish a control plane signalling connection to an SMF through an NG interface 4 (N4). The UPF may exchange user plane data with a data network through an NG interface 6 (N6). The AMF may establish a control plane signalling connection to the SMF through an NG interface 11 (N11). The SMF may establish a control plane signalling connection to a policy control function (PCF) through an NG interface 7 (N7).

FIG. 1 illustrates one base station, one core device, and two terminals. In an implementation, the radio communication system 100 includes multiple base stations and each base station may cover another number of terminals, which is not limited in embodiments of the disclosure.

Note that FIG. 1 merely as an example illustrates a system to which the disclosure is applicable. The method according to embodiments of the disclosure may further be applied to another system. In addition, terms “system” and “network” in the disclosure are often interchangeable in usage. A term “and/or” in the disclosure describes just an association between associated objects, including three possible relationships. For example, A and/or B may represent three cases, namely, existence of just A, existence of both A and B, or existence of just B. A slash mark “/” in the disclosure generally represents an “or” relationship between two associated objects that come respectively before and after the mark per se. Further note that “indication/indicate” mentioned in embodiments of the disclosure may refer to direct indication or indirect indication, and may further mean an association relation. For example, by saying that A indicates B, it may mean that A indicates B directly, such as when B may be acquired through A; it may mean that A indicates B indirectly, such as when A indicates C and B may be acquired through C; or it may mean an association relation between A and B. Further note that a term “corresponding” mentioned in embodiments of the disclosure may mean a direct correspondence or an indirect correspondence between two items, an association between the two, or a relation of indicating and being indicated, configuring and being configured, etc. Further note that “predefining” or “predefined rule” mentioned in embodiments of the disclosure may be achieved by saving a corresponding code and/or table beforehand in a device (including a terminal and a network device, for example), or in another mode that may be configured to indicate related information, the specific implementation of which is not limited in embodiments of the disclosure. For example, “predefined” may be as defined in a protocol. Further note that in embodiments of the disclosure, a protocol may refer to a standard protocol in the field of communications, and may include, for example, an LTE protocol, an NR protocol, and a related protocol applying to a future communication system, which is not limited in embodiments of the disclosure.

To facilitate understanding the technical solution according to embodiments of the disclosure, art related to embodiments of the disclosure is illustrated hereinafter. The following related art may be combined, as optional schemes, with the technical solution according to embodiments of the disclosure as needed. All resulting solutions thus acquired fall in the scope of embodiments of the disclosure.

At present, data are transmitted in a network just in a data propagation mode under which data are sent simply from node A to node B. Such a data transmission mode may lead to propagation of a great amount of data, and the receiving end has to process received data to extract useful information. As an example, as illustrated in FIG. 2A, a terminal may send data directly to an application server through a mobile network; or vice versa, the application server may send data directly to the terminal through the mobile network. Here, the mobile network may be, but is not limited to, a 5G network. Such a data transmission mode in FIG. 2A is inefficient, mainly in two aspects as follows. In one aspect, the amount of data transmitted in the network may increase significantly with explosive increase in the amount of data, increasingly overburdening the network. In the other aspect, a growing amount of data are also received by the receiving end, which also has to process a growing amount of data, thus the risk of overburdening the receiving end is increased.

In view of this, a technical solution according to embodiments of the disclosure is proposed as follows.

As an example, as illustrated in FIG. 2B, the mobile network provides not only a data transmission capacity, but also a data processing capacity. After a terminal sends data to the mobile network, one or more nodes in the mobile network may process the data to extract useful information, and send a data processing result (i.e., the useful information) to the application server, thus not only reducing the amount of data transmitted by the network greatly, relieving the burden on the network, but also relieving the amount of (data processing) work for the receiving end.

Note that although FIG. 2B illustrates data processing by a node in the mobile network, it is not limited hereto. The terminal may also process the data. That is, the terminal and/or at least one node in the mobile network may process the data.

In order for the terminal and/or the at least one node in the mobile network to process the data, a data processor has to be introduced into the terminal and/or at least one mobile network node (i.e., the at least one node in the mobile network) to implement the data processing capacity.

To facilitate understanding the technical solution according to embodiments of the disclosure, the technical solution of the disclosure is elaborated hereinafter with specific embodiments. The above related art may be combined, as optional schemes, with the technical solution according to embodiments of the disclosure as needed. All resulting solutions thus acquired shall fall in the scope of embodiments of the disclosure. Embodiments of the disclosure include at least some of the following content.

Note that the technical solution according to embodiments of the disclosure may be applied, but not limited to being applied, to a 5G network, and may also apply to a 6G network, etc., for example. A network node involved in embodiments of the disclosure is illustrated by the name of a 5G node, which however poses no limitation to the technical solution according to embodiments of the disclosure.

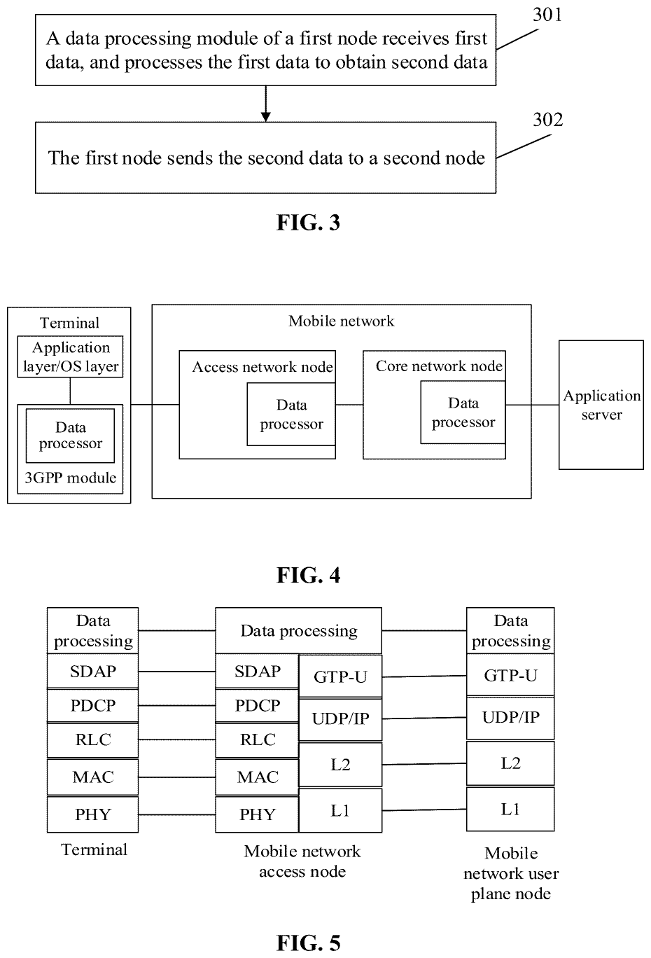

FIG. 3 is a flowchart of a method for transmitting data according to embodiments of the disclosure. As illustrated in FIG. 3, the method for transmitting data includes operations as follows.

At operation 301, a data processor of a first node receives first data, and processes the first data to obtain second data.

At operation 302, the first node sends the second data to a second node.

In embodiments of the disclosure, the first node has a data processor. In some implementations, a function provided by the data processor includes at least one of:
receiving and analyzing data from a last node or a higher layer;
processing data obtained from the analysis to obtain a data processing result; or
sending the data processing result to a next node.

Specifically, after receiving the data from the last node or the higher layer, the data processor may analyze the received data, thereby obtaining content of the data. Then, the data processor may process the obtained content of the data to extract useful information, obtaining the data processing result (i.e., the useful information). The data processor may send the obtained data processing result to the next node.

Note that the data processing result may be useful information (knowledge) extracted from raw data, or a result obtained by performing specific processing on the raw data.

Further, in some implementations, the function provided by the data processor may further include at least one of following operations:
performing at least one of decryption or integrity protection check on the acquired data; or
performing at least one of encryption or integrity protection on the data processing result to be sent.

Specifically, after receiving the data from the last node or the higher layer, the data processor may analyze the received data, thereby obtaining content of the data. The data processor may perform at least one of decryption or integrity protection check on the obtained content of the data, and process the content of the data after at least one of successful decryption or successful integrity protection check, to extract useful information, obtaining the data processing result (i.e., the useful information). The data processor may perform at least one of encryption or integrity protection on the data processing result, and send the data processing result subjected to at least one of encryption or integrity protection to the next node.

In a foregoing solution, analysis may also be replaced by sensing in associated description. Specifically, the data processor may analyze (i.e., sense) content corresponding to a specific protocol layer (which may be referred to as a data processing layer).

In some implementations, the first node may be a terminal or a mobile network node. The mobile network node may include but is not limited to a mobile network access node (such as a base station), a mobile network control plane node (such as a UPF), etc.

In embodiments of the disclosure, the terminal and/or at least one mobile network node has a data processor. As an example, as illustrated in FIG. 4, each of the terminal, an access network node in the mobile network, and a core network node in the mobile network has a data processor. The access network node in the mobile network may also be referred to as a mobile network access node (such as a base station). The core network node in the mobile network is a mobile network user plane node (such as a UPF), for example. Refer to description of a foregoing related solution for a function of a data processor in a node. The data processors of respective nodes may collaborate to process data. A final data processing result may be sent to the application server.

The technical solution according to embodiments of the disclosure is illustrated hereinafter with reference to different implementations of the first node.

### Case 1

In some implementations, the first node is a terminal.

A data processor of the terminal may receive the first data from an application layer or an operating system (OS) layer of the terminal. The data processor of the terminal may process the first data to obtain the second data. The terminal may send the second data to a mobile network access node or a mobile network user plane node. Here, as an example, the mobile network access node may be a base station. The mobile network user plane node may be a UPF.

In some implementations, a protocol layer corresponding to the data processor is a data processing layer and the first node is a terminal. As an implementation, the data processing layer is implemented as a new protocol layer. The data processing layer (i.e., the new protocol layer) may be located above a service data adaptation protocol (SDAP) layer. As another implementation, a function of the data processing layer is implemented by an existing protocol layer (referred to as a first protocol layer). Optionally, the first protocol layer may be the SDAP layer or a protocol layer below the SDAP layer. For example, the function of the data processing layer is implemented by the SDAP layer or a packet data convergence protocol (PDCP) layer. In this case, the function of the existing protocol layer is required to be extended to include the function of the data processing layer.

In a specific implementation, the data processor in the terminal may be located in a 3rd generation partnership project (3GPP) module of the terminal. Here, the 3GPP module may be a modem. Not limited hereto, the data processor in the terminal may further be located at another location, such as in the OS of the terminal.

### Case 2

In some implementations, the first node is a mobile network access node. Here, as an example, the mobile network access node is a base station.

In solution 1, a data processor of the mobile network access node may receive the first data from a terminal. The data processor of the mobile network access node may process the first data to obtain the second data. The mobile network access node may send the second data to a mobile network user plane node.

In a foregoing solution, optionally, the first data may be obtained by processing third data by a data processor of the terminal.

As an example, the terminal may receive the third data from the application layer or the OS layer, process the third data to obtain the first data, and send the first data to the mobile network access node. The mobile network access node may process the first data to obtain the second data, and send the second data to the mobile network user plane node. Further, optionally, the mobile network user plane node may process the second data to obtain fourth data, and send the fourth data to the application server.

In solution 2, a data processor of the mobile network access node may receive the first data from a mobile network user plane node. The data processor of the mobile network access node may process the first data to obtain the second data. The mobile network access node may send the second data to a terminal.

In a foregoing solution, optionally, the first data may be obtained by processing third data by a data processor of the mobile network user plane node.

As an example, the mobile network user plane node may receive the third data from the application server, process the third data to obtain the first data, and send the first data to the mobile network access node. The mobile network access node may process the first data to obtain the second data, and send the second data to the terminal. Further, optionally, the terminal may process the second data to obtain fourth data, and send the fourth data to the application layer or the OS layer.

In a foregoing solution, the mobile network user plane node may be a user plane function (UPF) network element, for example.

In some implementations, a protocol layer corresponding to the data processor is a data processing layer and the first node is a mobile network access node. As an implementation, the data processing layer is implemented as a new protocol layer. The data processing layer (i.e., the new protocol layer) may be located above at least one of a service data adaptation protocol (SDAP) layer or a general packet radio service (GPRS) tunnel protocol-user plane (GTP-U) layer. As another implementation, a function of the data processing layer may be implemented by an existing protocol layer (referred to as a second protocol layer). Optionally, the second protocol layer may be implemented as a SDAP layer or a protocol layer below the SDAP layer. For example, the function of the data processing layer may be implemented by the SDAP layer or a packet data convergence protocol (PDCP) layer. In this case, the function of the existing protocol layer is required to be extended to include the function of the data processing layer.

### Case 3

In some implementations, the first node is a mobile network user plane node. Here, as an example, the mobile network user plane node is a UPF.

In solution 1, a data processor of the mobile network user plane node may receive first data from a mobile network access node or a terminal. The data processor of the mobile network user plane node may process the first data to obtain second data. The mobile network user plane node may send the second data to an application server.

In a foregoing solution, optionally, the first data may be obtained by processing third data by a data processor of the mobile network access node or the terminal.

As an example, the mobile network access node may receive third data from the terminal, process the third data to obtain the first data, and send the first data to the mobile network user plane node. The mobile network user plane node may process the first data to obtain the second data, and send the second data to the application server.

In solution 2, a data processor of the mobile network user plane node may receive the first data from an application server. The data processor of the mobile network user plane node may process the first data to obtain the second data. The mobile network user plane node may send the second data to a mobile network access node or a terminal. Further, optionally, in case the mobile network user plane node sends the second data to the mobile network access node, the mobile network access node may process the second data to obtain fourth data, and send the fourth data to the terminal.

In some implementations, a protocol layer corresponding to the data processor is a data processing layer and the first node is a mobile network user plane node. As an implementation, the data processing layer is implemented as a new protocol layer. The data processing layer (i.e., the new protocol layer) may be located above a general packet radio service (GPRS) tunnel protocol-user plane (GTP-U) layer. As another implementation, a function of the data processing layer is implemented by an existing protocol layer (referred to as a third protocol layer). Optionally, the third protocol layer may be implemented as the GTP-U layer or a protocol layer below the GTP-U layer. For example, the function of the data processing layer may be implemented by the GTP-U layer. In this case, the function of the existing protocol layer is required to be extended to include the function of the data processing layer.

As an example, as illustrated in FIG. 5, in a protocol stack, the data processor corresponds to a data processing layer. A location of the data processing layer is illustrated in FIG. 5. The data processing layer at the terminal side may be located above the SDAP layer. The data processing layer at the mobile network access node (such as the base station) side may be located above the SDAP layer and the GTP-U layer. The data processing layer at the mobile network user plane node (such as the UPF) side is located above the GTP-U layer. Further, optionally, the data processing layer is located below a protocol data unit (PDU) layer at the mobile network user plane node (such as the UPF) side as well as the terminal.

In any one of case 1 to case 3, in some implementations, the first node may perform at least one of decryption or integrity protection check on the first data before processing the first data.

In any one of case 1 to case 3, in some implementations, the first node may perform at least one of encryption or integrity protection on the second data before sending the second data to the second node.

Note that the encryption mechanism and/or the integrity protection mechanism may be used by some, all, or none of nodes involved in the data transmission process. Here, use of the encryption mechanism may refer to decrypting received data and/or encrypting data to be sent. Use of the integrity protection mechanism may refer to performing integrity protection check on the received data and/or performing integrity protection on the data to be sent.

Here, before data transmission is performed, nodes to be involved in the data transmission need to acquire a key in order to perform decryption and/or integrity protection check on the received data and/or perform encryption and/or integrity protection on the data to be sent according to the key.

In some implementations, when a connection for the data transmission is established, the mobile network control plane node may determine the key and send the key to the nodes to be involved in the data transmission. Here, the nodes involved in the data transmission may include at least one of a terminal, a mobile network access node, a mobile network user plane node, or an application server.

In any one of case 1 to case 3, in some implementations, the first data may be processed as follows. The first node may perform at least one of model inference, model training, compression, induction, or packet analysis on the first data.

What described are just examples. Any goal and/or effect achievable by packet sensing/processing by a communication network node may be implemented by the solution.

In a foregoing solution, the model inference may refer to inputting data to a model and processing the data by the model to infer (or predict) a result.

In a foregoing solution, the model training may refer to inputting data to a model, processing the data by the model, and updating a parameter in the model according to a result inferred (or predicted) by the model.

In a foregoing solution, the compression may refer to compressing data.

In a foregoing solution, the induction may refer to processing data according to a specific induction algorithm or a specific induction policy to implement specific induction.

In a foregoing solution, the packet analysis may refer to analyzing a received data stream or a received packet to extract useful information, such as to identify an application or service corresponding to the data stream, identify content corresponding to the data stream, etc.

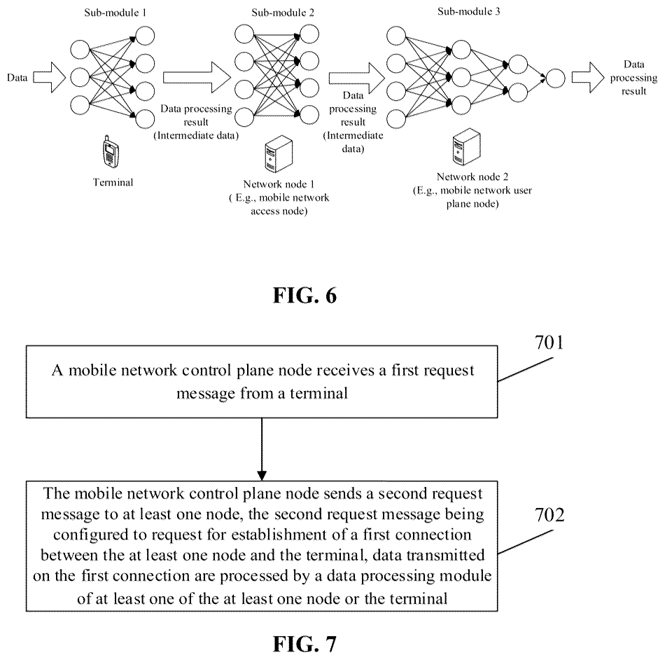

As illustrated in FIG. 6, taking the model inference as an example, the model has a total of N layers. N may be a positive integer. The model may be partitioned into three sub-models. A first layer to an i-th layer of the model may be partitioned into sub-model 1. An (i+1)-th layer to a j-th layer of the model may be partitioned into sub-model 2. The j-th layer to an N-th layer of the model may be partitioned into sub-model 3. i and j may be positive integers, and 2<i+1<j<N. The data processor of the terminal may call sub-model 1 to process raw data, and send an obtained data processing result to the mobile network access node. The mobile network access node may call sub-model 2 to further process the data processing result from the terminal, and send an obtained data processing result to the mobile network user plane node. The mobile network user plane node may call sub-model 3 to further process the data processing result from the mobile network access node, and send an obtained data processing result to the application server. The terminal, the mobile network access node, and the mobile network user plane node may collaborate to process the raw data during the whole process. The acquired final data processing result may be sent to the application server.

Taking the compression as an example, the data processor of the terminal may compress the raw data, and send an obtained data processing result to the mobile network access node. The mobile network access node may further compress the data processing result from the terminal, and send an obtained data processing result to the mobile network user plane node. The mobile network user plane node may further compress the data processing result from the mobile network access node, and send an obtained data processing result to the application server. The terminal, the mobile network access node, and the mobile network user plane node may collaborate to process the raw data during the whole process. The acquired final data processing result may be sent to the application server.

Note that although some foregoing examples are illustrated taking uplink transmission as an example, the technical solution according to embodiments of the disclosure may also be applied to downlink transmission.

With the technical solution according to embodiments of the disclosure, a terminal and/or at least one node in a mobile network may collaborate to process data from an application of the terminal. A data processing result may be sent to an application server. Alternatively, the at least one node in the mobile network may process data from the application server, and send a data processing result to the terminal. In this way, in one aspect, it is the data processing result instead of the raw data that is transmitted to a receiving end, therefore reducing the amount of data transmitted by the network, as the amount of data of the data processing result is less than the amount of data of the raw data. In the other aspect, it is the processed data processing result that is received by the receiving end, and therefore useful information is acquired with no need for further data processing, relieving the burden on the application layer.

A connection is needed to be established to implement the data transmission process. Data transmitted on the connection may be processed by the terminal and/or the at least one node in the mobile network. As an example, the connection may be referred to as a data processing connection.

FIG. 7 is flowchart 1 of a method for establishing a connection according to embodiments of the disclosure. As illustrated in FIG. 7, the method for establishing a connection includes operations as follows.

At operation 701, a mobile network control plane node receives a first request message from a terminal.

In embodiments of the disclosure, the terminal sends the first request message to the mobile network control plane node. Accordingly, the mobile network control plane node may receive the first request message from the terminal. The first request message is configured to trigger the mobile network control plane node to send a second request message to at least one node, as illustrated in operation 702.

In some implementations, the mobile network control plane node may be a core control plane network element. As an example, the core control plane network element is a session management function (SMF) network element.

In some implementations, the first request message may carry at least one of an application identifier, key information, an operation identifier, or a capacity parameter.

The application identifier may be for use by the data processor to identify data of a specific application.

The key information may be for use by the data processor to perform at least one of decryption or integrity protection check on received data, and for use by the data processor to perform at least one of encryption or integrity protection on data to be sent.

The operation identifier may be for use by the data processor to identify specific data of the specific application, and/or for use by the data processor to determine a data processing policy.

The capacity parameter may indicate a data processing capacity of the terminal.

In a foregoing solution, optionally, the application identifier may further identify a specific task or behavior. Here, the data processor may process the received data according to the specific task or behavior identified by the data processor. As an example, the specific task or behavior is an image recognition task, a speech recognition task, a radio positioning behavior, etc. Note that application identifier may also be replaced by service identifier in associated description.

In a foregoing solution, optionally, the key information may be generated during a process of registration or attachment of the terminal. Specifically, a new key or an intermediate key may be generated by the terminal and/or the network in the process that the terminal registers at, or attaches to, the network. The terminal may carry the new key or the intermediate key through the first request message when interacting with the mobile network control plane node to establish a connection. In an implementation, the terminal may carry the new key directly through the first request message. As another implementation, the terminal may generate a temporary new key according to the intermediate key, and carry the generated temporary new key through the first request message. For example, an authentication process is involved in the process that the terminal registers at, or attaches to, the network. For example, a new key or an intermediate key (such as a key Kausf) may be generated by the terminal and/or the network during 5G authentication (5G-AKA). When interacting with the mobile network control plane node to establish a connection, the terminal may carry the new key through the first request message; or generate a temporary new key according to the intermediate key (such as the key Kausf), and carry the generated temporary new key through the first request message.

In some implementations, if the terminal carries no key information through the first request message when interacting with the mobile network control plane node to establish a connection, the mobile network control plane node then may use the new key generated during the process of registration or attachment directly, or generate a temporary new key according to the intermediate key generated during the process of registration or attachment and use the generated temporary new key.

In a foregoing solution, optionally, the operation identifier may further identify an additional condition of the specific task or behavior. As an example, the additional condition of the specific task or behavior is a category of the image recognition task, a category of the speech recognition task, a condition of the radio positioning behavior, etc.

In a foregoing solution, optionally, the operation identifier may be for use to determine the data processing policy. As an example, the operation identifier may identify a partitioning point for partitioning the model. For example, partitioning points for partitioning the model may be at the i-th layer and the j-th layer. The model may have a total of N layers. N may be a positive integer. The model may be partitioned into three sub-models by the partitioning points. The first layer to the i-th layer of the model may be partitioned into sub-model 1. The (i+1)-th layer to the j-th layer of the model may be partitioned into sub-model 2. The j-th layer to the N-th layer of the model may be partitioned into sub-model 3. i and j may be positive integers, and 2<i+1<j<N.

In a foregoing solution, optionally, the capacity parameter may indicate the data processing capacity of the terminal. For example, the capacity parameter may indicate at least one of computing power of the terminal, a model or algorithm stored at the terminal, a model or algorithm supported by the terminal, etc.

At operation 702, the mobile network control plane node sends a second request message to at least one node, the second request message being configured to request for establishment of a first connection between the at least one node and the terminal. Data transmitted on the first connection are processed by a data processor of at least one of the at least one node or the terminal.

In embodiments of the disclosure, information carried in the first request message is for use by the mobile network control plane node to determine information to be carried in the second request message.

Here, after receiving the first request message, the mobile network control plane node may send the second request message to the at least one node. In some implementations, the second request message may carry at least one of an application identifier, key information, or an operation identifier.

The application identifier may be for use by the data processor to identify data of a specific application.

The key information may be for use by the data processor to perform at least one of decryption or integrity protection check on received data, and for use by the data processor to perform at least one of encryption or integrity protection on data to be sent.

The operation identifier may be for use by the data processor to identify specific data of the specific application, and/or for use by the data processor to determine a data processing policy.

In a foregoing solution, if any one or more of the application identifier, the key information, or the operation identifier is not carried in the first request message, the mobile network control plane node may then determine one or more of the application identifier, the key information, or the operation identifier, and carry the determined information in the second request message. The mobile network control plane node may select one or more pieces of information carried in the first request message and carry the selected information in the second request message, or update the information carried in the first request message and carry the updated information in the second request message.

In a foregoing solution, the at least one node may include at least one of a mobile network access node, a mobile network user plane node, or an application server. Here, the mobile network access node may be a base station. The mobile network user plane node may be a UPF. Note that there may be one or more mobile network user plane nodes. When there are multiple mobile network user plane nodes, the multiple mobile network user plane nodes may interact with the mobile network control plane node respectively to establish connections.

Further, in some implementations, the mobile network control plane may receive a second response message from the at least one node. The second response message may be a response message to the second request message.

Further, in some implementations, the mobile network control plane node may send a first response message to the terminal. Accordingly, the terminal may receive from the mobile network control plane node the first response message in response to the first request message. In some implementations, the first response message may include at least one of the application identifier, the key information, or the operation identifier.

The application identifier may be for use by the data processor to identify the data of the specific application.

The key information may be for use by the data processor to perform at least one of decryption or integrity protection check on the received data, and for use by the data processor to perform at least one of encryption or integrity protection on the data to be sent.

The operation identifier may be for use by the data processor to identify the specific data of the specific application, and/or for use by the data processor to determine the data processing policy.

In a foregoing solution, optionally, a request message in associated description may also be referred to as a connection establishment request message. Aresponse message in associated description may also be referred to as a connection establishment response message. For example, the connection establishment response message may be a connection establishment success message.

In embodiments of the disclosure, with the established first connection, while data are sent by the terminal to the application server through the mobile network, or by the application server to the terminal through the mobile network, the data are processed by the terminal and/or one or more nodes in the mobile network. An acquired final data processing result is sent to a peer (the terminal or the application server).

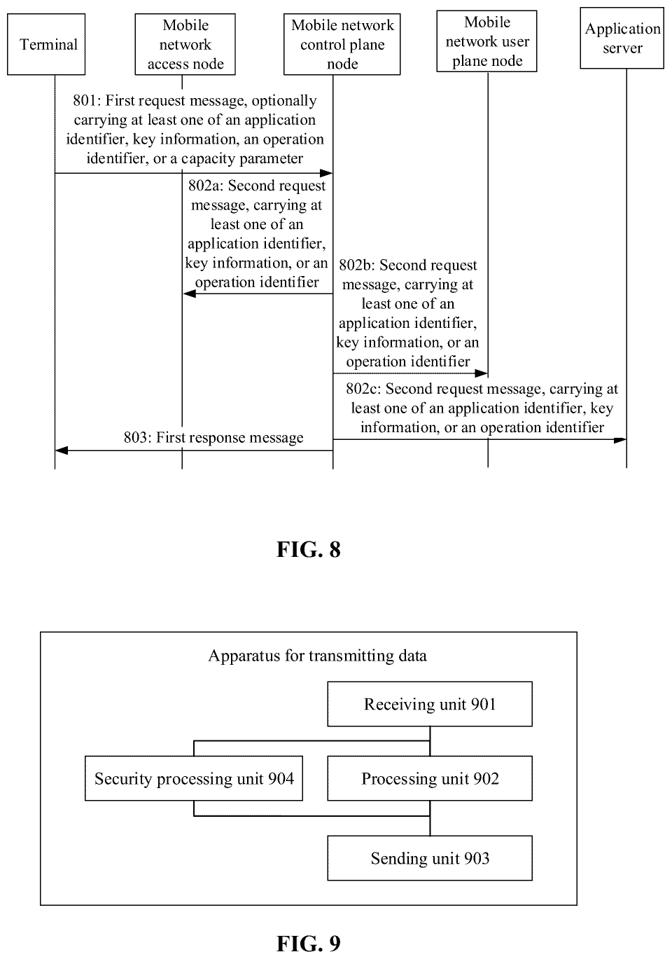

FIG. 8 is flowchart 2 of the method for establishing a connection according to embodiments of the disclosure. As illustrated in FIG. 8, the method for establishing a connection may include operations as follows.

At operation 801, a terminal sends a first request message to a mobile network control plane node.

In some implementations, the first request message may carry at least one of an application identifier, key information, an operation identifier, or a capacity parameter.

The application identifier may be for use by the data processor to identify data of a specific application.

The key information may be for use by the data processor to perform at least one of decryption or integrity protection check on received data, and for use by the data processor to perform at least one of encryption or integrity protection on data to be sent.

The operation identifier may be for use by the data processor to identify specific data of the specific application, and/or for use by the data processor to determine a data processing policy.

The capacity parameter may indicate a data processing capacity of the terminal.

At operation 802a/b/c, the mobile network control plane node may send a second request message to at least one of a mobile network access node, a mobile network user plane node, or an application server.

In some implementations, the second request message may carry at least one of an application identifier, key information, or an operation identifier.

The application identifier may be for use by the data processor to identify data of a specific application.

The key information may be for use by the data processor to perform at least one of decryption or integrity protection check on received data, and for use by the data processor to perform at least one of encryption or integrity protection on data to be sent.

The operation identifier may be for use by the data processor to identify specific data of the specific application, and/or for use by the data processor to determine a data processing policy.

At operation 803, the mobile network control plane node may send a first response message to the terminal.

Here, the first response message may be a connection establishment success message.

In some implementations, the first response message may carry at least one of the application identifier, the key information, or the operation identifier.

The application identifier may be for use by the data processor to identify the data of the specific application.

The key information may be for use by the data processor to perform at least one of decryption or integrity protection check on the received data, and for use by the data processor to perform at least one of encryption or integrity protection on the data to be sent.

The operation identifier may be for use by the data processor to identify the specific data of the specific application, and/or for use by the data processor to determine the data processing policy.

Note that it may suffice to perform just one of the operations 802a, 802b, and 802c. Alternatively, two or all three of the operations may be performed. For example, nodes involved in the first connection include the terminal, the mobile network user plane node, and the application server. Then, it may suffice to perform just operation 802b and operation 802c. For example, nodes involved in the first connection include the terminal, the mobile network access node, the mobile network user plane node, and the application server. Then, operation 802a, operation 802b, and operation 802c are required to be performed.

Note that an order in which the operations 802a, 802b, and 802c are performed is not limited.

Implementations according to the disclosure are elaborated with reference to the drawings. However, the disclosure is not limited to specifics in the implementations. Multiple straightforward variations may be made to a technical solution of the disclosure within the scope of the technical concept of the disclosure. All of these straightforward variations fall in the scope of the disclosure. For example, respective specific technical features described in implementation may be combined in any suitable mode as long as no contradiction results. Various possible combinations are not described separately in the disclosure to avoid unnecessary repetition. As another example, various different implementations according to the disclosure may be combined as desired as long as the combination does not go against the concept of the disclosure, and the combination should also be deemed falling in the scope of the disclosure. As another example, embodiments illustrated in the disclosure and/or technical features in the embodiments may be combined with related art as needed, as long as no conflict results from the combination. A technical solution resulting from the combination shall also fall in the scope of the disclosure.

Further note that in various method embodiments of the disclosure, a magnitude of a sequence number of a foregoing process does not indicate an order in which the process is executed. The processes are to be executed in an order determined by functions and intrinsic logics of the processes. Such a sequence number shall constitute no limit to implementation of the embodiments of the disclosure. In addition, in embodiments of the disclosure, a term such as “downlink”, “uplink”, “sidelink”, etc., represents a transmission direction in which a signal or a data is transmitted. “Downlink” represents a first direction in which the signal or the data is transmitted from a station point to a UE in a cell. “Uplink” represents a second direction in which the signal or the data is transmitted from the UE in the cell to the station point. “Sidelink” represents a third direction in which the signal or the data is transmitted from UE 1 to UE 2. For example, a downlink signal is transmitted in the first direction. In addition, in embodiments of the disclosure, a term “and/or” describes an association between associated objects, including three possible relationships. Specifically, by A and/or B, it may mean that there are three cases, namely, existence of just A, existence of both A and B, or existence of just B. In addition, a slash mark “/” in the disclosure generally represents an “or” relationship between two associated objects that come respectively before and after the mark per se.

FIG. 9 is a diagram of a structural composition of an apparatus for transmitting data according to embodiments of the disclosure. The apparatus is applied to a first node. The first node has a data processor. As illustrated in FIG. 9, the apparatus may include a receiving unit, a processing unit, and a sending unit.

The receiving unit 901 is configured to receive first data.

The processing unit 902 is configured to process the first data through the data processor to obtain second data.

The sending unit 903 is configured to send the second data to a second node.

In some implementations, the first node is a terminal;

The receiving unit 901 may be configured to receive, through a data processor of the terminal, the first data from an application layer or an operating system (OS) layer of the terminal.

The sending unit 903 may be configured to send the second data to a mobile network access node or a mobile network user plane node.

In some implementations, the first node is a mobile network access node;

The receiving unit 901 may be configured to receive, through a data processor of the mobile network access node, the first data from a terminal.

The sending unit 903 may be configured to send the second data to a mobile network user plane node.

In some implementations, the first data may be obtained by processing third data by a data processor of the terminal.

In some implementations, the first node is a mobile network access node;

The receiving unit 901 may be configured to receive, through a data processor of the mobile network access node, the first data from a mobile network user plane node.

The sending unit 903 may be configured to send the second data to a terminal.

In some implementations, the first data may be obtained by processing third data by a data processor of the mobile network user plane node.

In some implementations, the first node is a mobile network user plane node;

The receiving unit 901 may be configured to receive, through a data processor of the mobile network user plane node, the first data from a mobile network access node or a terminal.

The sending unit 903 may be configured to send the second data to an application server.

In some implementations, the first data may be obtained by processing third data by a data processor of the mobile network access node or the terminal.

In some implementations, the first node is a mobile network user plane node;

The receiving unit 901 may be configured to receive, through a data processor of the mobile network user plane node, the first data from an application server.

The sending unit 903 may be configured to send the second data to a mobile network access node or a terminal.

In some implementations, a protocol layer corresponding to the data processor is a data processing layer, and when the first node is a terminal, the data processing layer is located above a service data adaptation protocol (SDAP) layer, or a function of the data processing layer is implemented by a first protocol layer. The first protocol layer may be the SDAP layer or a protocol layer below the SDAP layer.

In some implementations, a protocol layer corresponding to the data processor is a data processing layer, and when the first node is a mobile network access node, the data processing layer is located above at least one of a service data adaptation protocol (SDAP) layer or a general packet radio service (GPRS) tunnel protocol-user plane (GTP-U) layer, or a function of the data processing layer is implemented by a second protocol layer. The second protocol layer may be the SDAP layer or a protocol layer below the SDAP layer.

In some implementations, a protocol layer corresponding to the data processor is a data processing layer, and when the first node is a mobile network user plane node, the data processing layer is located above a general packet radio service (GPRS) tunnel protocol-user plane (GTP-U) layer, or a function of the data processing layer is implemented by a third protocol layer. The third protocol layer may be the GTP-U layer or a protocol layer below the GTP-U layer.

In some implementations, the apparatus may further include a security processing unit 904 configured to perform at least one of decryption or integrity protection check on the first data.

In some implementations, the apparatus may further include a security processing unit 904 configured to perform at least one of encryption or integrity protection on the second data.

In some implementations, the first data are processed as follows.

The first node may perform at least one of model inference, model training, compression, induction, or packet analysis on the first data.

A person having ordinary skill in the art will understand illustration related to a foregoing apparatus for transmitting data according to embodiments of the disclosure by referring to illustration related to a method for transmitting data according to embodiments of the disclosure.

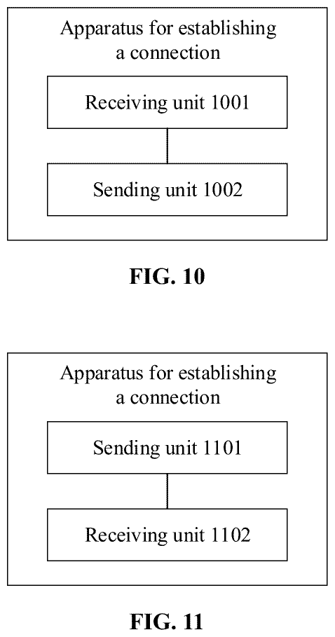

FIG. 10 is diagram 1 of a structural composition of an apparatus for establishing a connection according to embodiments of the disclosure. The apparatus is applied to a mobile network control plane node. As illustrated in FIG. 10, the apparatus may include a receiving unit and a sending unit.

The receiving unit 1001 is configured to receive a first request message from a terminal.

The sending unit 1002 is configured to send a second request message to at least one node, the second request message being configured to request for establishment of a first connection between the at least one node and the terminal. Data transmitted on the first connection are processed by a data processor of at least one of the at least one node or the terminal.

In some implementations, the first request message may carry at least one of:
an application identifier, for use by the data processor to identify data of a specific application;
key information, for use by the data processor to perform at least one of decryption or integrity protection check on received data, and for use by the data processor to perform at least one of encryption or integrity protection on data to be sent;
an operation identifier, for use by the data processor to identify specific data of the specific application, and/or for use by the data processor to determine a data processing policy; or
a capacity parameter indicating a data processing capacity of the terminal.

In some implementations, information carried in the first request message may be for use by the mobile network control plane node to determine information to be carried in the second request message.

In some implementations, the second request message may carry at least one of.
an application identifier, for use by the data processor to identify data of a specific application;
key information, for use by the data processor to perform at least one of decryption or integrity protection check on received data, and for use by the data processor to perform at least one of encryption or integrity protection on data to be sent; or
an operation identifier, for use by the data processor to identify specific data of the specific application, and/or for use by the data processor to determine a data processing policy.

In some implementations, the sending unit 1002 is further configured to send a first response message in response to the first request message to the terminal.

In some implementations, the at least one node may include at least one of a mobile network access node, a mobile network user plane node, or an application server.

A person having ordinary skill in the art will understand illustration related to a foregoing apparatus for establishing a connection according to embodiments of the disclosure by referring to illustration related to a method for establishing a connection according to embodiments of the disclosure.

FIG. 11 is diagram 2 of the structural composition of the apparatus for establishing a connection according to embodiments of the disclosure. The apparatus is applied to a terminal. As illustrated in FIG. 11, the apparatus may include a sending unit.

The sending unit 1101 is configured to send a first request message to a mobile network control plane node. The first request message is configured to trigger the mobile network control plane node to send a second request message to at least one node, request for establishment of a first connection between the at least one node and the terminal. Data transmitted on the first connection are processed by a data processor of at least one of the at least one node or the terminal.

In some implementations, the first request message may carry at least one of:
an application identifier, for use by the data processor to identify data of a specific application;
key information, for use by the data processor to perform at least one of decryption or integrity protection check on received data, and for use by the data processor to perform at least one of encryption or integrity protection on data to be sent;
an operation identifier, for use by the data processor to identify specific data of the specific application, and/or for use by the data processor to determine a data processing policy; or
a capacity parameter indicating a data processing capacity of the terminal.

In some implementations, the apparatus may further include a receiving unit.

The receiving unit 1102 may be configured to receive a first response message from the mobile network control plane node in response to the first request message.

In some implementations, the at least one node may include at least one of a mobile network access node, a mobile network user plane node, or an application server.

A person having ordinary skill in the art will understand illustration related to a foregoing apparatus for establishing a connection according to embodiments of the disclosure by referring to illustration related to a method for establishing a connection according to embodiments of the disclosure.

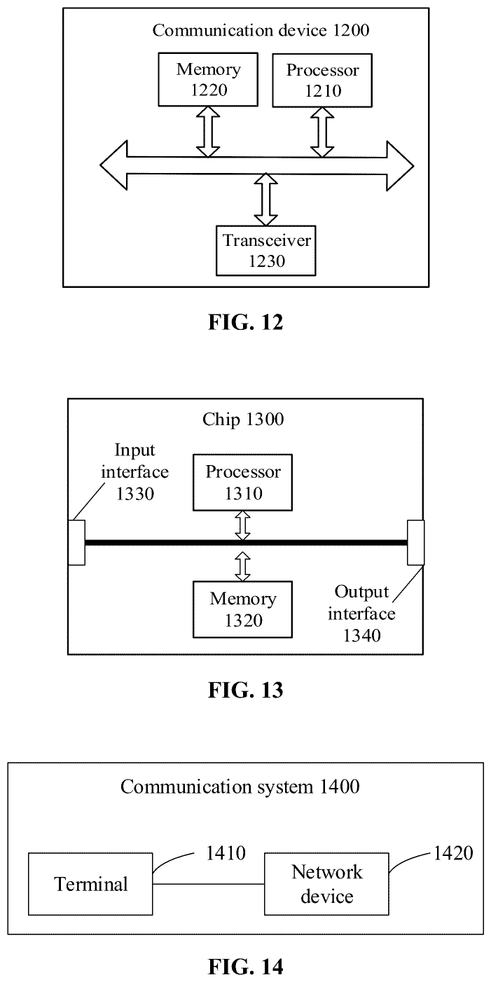

FIG. 12 is a diagram of a structure of a communication device 1200 according to embodiments of the disclosure. The communication device may be a terminal or a network device (such as the mobile network node in a foregoing solution). The communication device 1200 as illustrated in FIG. 12 may include a processor 1210. The processor 1210 may call and run a computer program in a memory to implement a method in embodiments of the disclosure.

In an implementation, as illustrated in FIG. 12, the communication device 1200 further includes a memory 1220. The processor 1210 may call and run a computer program in the memory 1220 to implement a method in embodiments of the disclosure.

The memory 1220 may be a separate device independent from the processor 1210, or may be integrated in the processor 1210.

In an implementation, as illustrated in FIG. 12, the communication device 1200 further includes a transceiver 1230. The processor 1210 may control communication by the transceiver 1230 with another device. Specifically, the transceiver transmits information or data to the other device, or receives information or data transmitted by the other device.

The transceiver 1230 may include a transmitter and a receiver. The transceiver 1230 may further include one or more antennas.

In an implementation, the communication device 1200 is a network device according to embodiments of the disclosure, and the communication device 1200 implements a corresponding flow implemented by a network device in a method according to embodiments of the disclosure, which is not repeated here for brevity.

In an implementation, the communication device 1200 is a mobile terminal/a terminal according to embodiments of the disclosure, and the communication device 1200 implements a corresponding flow implemented by a mobile terminal/a terminal in a method according to embodiments of the disclosure, which is not repeated here for brevity.

FIG. 13 is a diagram of a structure of a chip according to embodiments of the disclosure. The chip 1300 as illustrated in FIG. 13 may include a processor 1310. The processor 1310 may call and run a computer program in a memory to implement a method in embodiments of the disclosure.

In an implementation, as illustrated in FIG. 13, the chip 1300 further includes a memory 1320. The processor 1310 may call and run a computer program in the memory 1320 to implement the method in embodiments of the disclosure.

The memory 1320 may be a separate device independent from the processor 1310, or may be integrated in the processor 1310.

Optionally, the chip 1300 further includes an input interface 1330. The processor 1310 may control communication by the input interface 1330 with another device or chip. Specifically, information or data transmitted by the other device or chip are acquired.

Optionally, the chip 1300 further includes an output interface 1340. The processor 1310 may control communication by the output interface 1340 with another device or chip. Specifically, information or data are output to the other device or chip.

Optionally, the chip applies to a network device in embodiments of the disclosure, and the chip implements a flow implemented by a network device in the method according to embodiments of the disclosure, which is not repeated here for brevity.

Optionally, the chip applies to a mobile terminal/a terminal in embodiments of the disclosure, and the chip implements a flow implemented by a mobile terminal/a terminal in the method according to embodiments of the disclosure, which is not repeated here for brevity.

Note that the chip mentioned in embodiments of the disclosure may also be referred to as a system-level chip, a system chip, a chip system, a SOC chip, etc.

FIG. 14 is a block diagram of a communication system 1400 according to embodiments of the disclosure. As illustrated in FIG. 14, the communication system 1400 may include a terminal 1410 and a network device 1420.

The terminal 1410 may be configured to implement a corresponding function implemented by a terminal in the method herein, and the network device 1420 may be configured to implement a corresponding function implemented by a network device in the method herein, which is not repeated here for brevity.

Note that the processor according to embodiments of the disclosure may be an integrated circuit chip capable of signal processing. In implementation, a step of a method embodiment herein may be carried out via an integrated logic circuit of hardware in the processor or instructions in form of software. The processor may be a general-purpose processor, a digital signal processor (DSP), an application specific integrated circuit (ASIC), a field programmable gate array (FPGA), or another programmable logic device, a discrete gate, or a transistor logic device, a discrete hardware component, etc. The processor may implement or execute various methods, steps, and logical block diagrams according to embodiments of the disclosure. A general-purpose processor may be a microprocessor or any conventional processor. A step of the method disclosed in embodiments of the disclosure may be directly embodied as being carried out by a hardware decoding processor, or by a combination of hardware and software modules in the decoding processor. A software module may be located in a mature storage medium in the art, such as a random access memory (RAM), a flash memory, a read only memory (ROM), a programmable read-only memory (PROM), an electrically rewritable programmable memory, a register, etc. The storage medium may be located in the memory. The processor may read information in the memory, and combine it with hardware of the processor to perform a step of a method herein.

Understandably, the memory in embodiments of the disclosure may be a volatile and/or a non-volatile memory. The non-volatile memory may be a read-only memory (ROM), a programmable ROM (PROM), an erasable PROM (EPROM), an electrically EPROM (EEPROM), or a flash memory, etc. The volatile memory may be a random access memory (RAM) serving as an external cache. By way of illustrative instead of restrictive description, there are many forms of RAM available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), a direct rambus RAM (DR RAM), etc. Note that the memory of the system and method described herein is intended to include, but is not limited to, these and any other memory of suitable types.

Understandably, the foregoing memory is described in an illustrative nonrestrictive way. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. That is, a memory in embodiments of the disclosure is intended to include, but is not limited to, these and any other memory of suitable types.

Embodiments of the disclosure further provide a computer-readable storage medium configured to store a computer program.

In an implementation, the computer-readable storage medium may be applied to a network device in embodiments of the disclosure, and the computer program allows a computer to execute a corresponding flow implemented by a network device in a method according to an embodiment of the disclosure, which is not repeated here for brevity.

In an implementation, the computer-readable storage medium may be applied to a mobile terminal/a terminal in embodiments of the disclosure, and the computer program allows a computer to execute a corresponding flow implemented by a mobile terminal/a terminal in the method according to an embodiment of the disclosure, which is not repeated here for brevity.

Embodiments of the disclosure further provide a computer program product including computer program instructions.

In an implementation, the computer program product may be applied to a network device in embodiments of the disclosure, and the computer program instructions allows a computer to execute a corresponding flow implemented by a network device in a method according to an embodiment of the disclosure, which is not repeated here for brevity.

In an implementation, the computer program product may be applied to a mobile terminal/a terminal in embodiments of the disclosure, and the computer program instructions allows a computer to execute a corresponding flow implemented by a mobile terminal/a terminal in the method according to an embodiment of the disclosure, which is not repeated here for brevity.

Embodiments of the disclosure further provide a computer program.

In an implementation, the computer program may be applied to a network device in embodiments of the disclosure. When being run on a computer, the computer program allows the computer to execute a corresponding flow implemented by a network device in the method according to an embodiment of the disclosure, which is not repeated here for brevity.

In an implementation, the computer program may be applied to a mobile terminal/a terminal in embodiments of the disclosure. When being run on a computer, the computer program allows the computer to execute a corresponding flow implemented by a mobile terminal/a terminal in the method according to an embodiment of the disclosure, which is not repeated here for brevity.

A person having ordinary skill in the art may realize that a unit and an algorithm step in an example according to embodiments of the disclosure may be implemented by electronic hardware or a combination of electronic hardware and computer software. Whether such a function is implemented by hardware or by software depends on a specific application of a technical solution as well as a design constraint. Depending on a specific application, a person having ordinary skill in the art may implement a described function using different methods. Such implementations however should not be deemed going beyond a scope of the disclosure.

A person having ordinary skill in the art will clearly understand that, for convenience and conciseness of description, reference may be made to a corresponding process in a foregoing method embodiment for a detailed working process of a system, an apparatus, a unit, etc., described above, which is not repeated here.

In a number of embodiments provided in the disclosure, it should be understood that a method, an apparatus, a system, etc., as disclosed, may be implemented in other ways. For example, a described apparatus embodiment is merely illustrative. For example, division of units is merely logic function division and there may be another division in actual implementation. For example, units or components may be combined, or integrated into another system, or some features/characteristics may be omitted or skipped. Furthermore, the coupling, or direct coupling or communicational connection illustrated or discussed herein may be implemented through indirect coupling or communicational connection among some interfaces, apparatuses, or units, and may be electrical, mechanical, or of another form.

The units described as separate components may or may not be physically separated. Components shown as units may be or may not be physical units. They may be located in one place, or distributed on multiple network units. Some or all of the units may be selected to achieve the purpose of a solution of the embodiments as needed.

In addition, functional units in embodiments of the disclosure may be integrated in one processing part, or exist as separate physical units respectively. Alternatively, two or more units may be integrated in one unit.

When implemented in form of a software functional unit and sold or used as an independent product, the function may be stored in a computer-readable storage medium. Based on such an understanding, the essential part or a part contributing to prior art of the technical solution of the disclosure or part of the technical solution may appear in form of a software product. The software product is stored in a storage medium, and includes a number of instructions for allowing computer device (such as a personal computer, a server, network device, etc.) to execute all or part of a method in an embodiment of the disclosure. The storage medium includes various media that may store program codes, such as a U disk, a mobile hard disk, Read-Only Memory (ROM), Random Access Memory (RAM), a magnetic disk, a CD, etc.

What described are merely embodiments of the disclosure and are not intended to limit the scope of the disclosure. Any modification, equivalent replacement, and/or the like made within the technical scope of the disclosure, as may occur to a person having ordinary skill in the art, shall be included in the scope of the disclosure. The scope of the disclosure thus should be determined by the claims.

1. A communication device for a mobile network control plane node to establish a connection, comprising: a processor, and a transceiver connected to the processor,
wherein the transceiver is configured to:
receive a first request message from a terminal; and
send a second request message to at least one node, the second request message being configured to request for establishment of a first connection between the at least one node and the terminal, wherein data transmitted on the first connection are processed by a data processor of at least one of the at least one node or the terminal.

2. The communication device of claim 1, wherein the first request message carries at least one of:
an application identifier, for use by the data processor to identify data of a specific application;
key information, for use by the data processor to perform at least one of decryption or integrity protection check on received data, and for use by the data processor to perform at least one of encryption or integrity protection on data to be sent;
an operation identifier, for use by the data processor to perform at least one of followings: identifying specific data of the specific application, or determining a data processing policy; or
a capacity parameter, for indicating a data processing capacity of the terminal.

3. The communication device of claim 2, wherein information carried in the first request message is for use by the mobile network control plane node to determine information to be carried in the second request message.

4. The communication device of claim 1, wherein the second request message carries at least one of:
an application identifier, for use by the data processor to identify data of a specific application;
key information, for use by the data processor to perform at least one of decryption or integrity protection check on received data, and for use by the data processor to perform at least one of encryption or integrity protection on data to be sent; or
an operation identifier, for use by the data processor to perform at least one of followings: identifying specific data of the specific application, or determining a data processing policy.

5. The communication device of claim 1, wherein the transceiver is further configured to:
send a first response message in response to the first request message to the terminal.

6. The communication device of claim 1, wherein the at least one node comprises at least one of: a mobile network access node, a mobile network user plane node, or an application server.

7. A communication device for a terminal to establish a connection, comprising: a processor, and a transceiver connected to the processor,
wherein the transceiver is configured to send a first request message to a mobile network control plane node, wherein the first request message is configured to trigger the mobile network control plane node to send a second request message to at least one node, the second request message being configured to request for establishment of a first connection between the at least one node and the terminal, wherein data transmitted on the first connection are processed by a data processor of at least one of the at least one node or the terminal.

8. The communication device of claim 7, wherein the first request message carries at least one of:
an application identifier, for use by the data processor to identify data of a specific application;
key information, for use by the data processor to perform at least one of decryption or integrity protection check on received data, and for use by the data processor to perform at least one of encryption or integrity protection on data to be sent;
an operation identifier, for use by the data processor to perform at least one of followings: identifying specific data of the specific application, or determining a data processing policy; or
a capacity parameter indicating a data processing capacity of the terminal.

9. The communication device of claim 7, wherein the transceiver is further configured to:
receive a first response message in response to the first request message from the mobile network control plane node.

10. The communication device of claim 7, wherein the at least one node comprises at least one of: a mobile network access node, a mobile network user plane node, or an application server.

11. A communication device for a first node to transmit data, comprising: a data processor, and a transceiver connected to the processor,
wherein the data processor is configured to receive first data and process the first data to obtain second data; and
the transceiver is configured to send the second data to a second node.

12. The communication device of claim 11, wherein the first node is a terminal,
wherein the data processor of the first node is configured to receive the first data from an application layer or an operating system (OS) layer of the terminal, and
the transceiver is configured to send the second data to a mobile network access node or a mobile network user plane node.

13. The communication device of claim 11, wherein the first node is a mobile network access node,
wherein the data processor of the first node is configured to receive the first data from a terminal, and
the transceiver is configured to send the second data to a mobile network user plane node.

14. The communication device of claim 13, wherein the first data are obtained by processing third data by a data processor of the terminal.

15. The communication device of claim 11, wherein the first node is a mobile network access node,
wherein the data processor of the first node is configured to receive the first data from a mobile network user plane node, and
the transceiver is configured to send the second data to a terminal.

16. The communication device of claim 15, wherein the first data are obtained by processing third data by a data processor of the mobile network user plane node.

17. The communication device of claim 11, wherein the first node is a mobile network user plane node,
wherein the data processor of the first node is configured to receive the first data from a mobile network access node or a terminal, and
the transceiver is configured to send the second data to an application server.

18. The communication device of claim 17, wherein the first data are obtained by processing third data by a data processor of the mobile network access node or the terminal.

19. The communication device of claim 11, wherein the first node is a mobile network user plane node,
wherein the data processor of the first node is configured to receive the first data from an application server, and
the transceiver is configured to send the second data to a mobile network access node or a terminal.

20. The communication device of claim 11, wherein a protocol layer corresponding to the data processor is a data processing layer, and when the first node is a terminal,
the data processing layer is located above a service data adaptation protocol (SDAP) layer, or
a function of the data processing layer is implemented by a first protocol layer, the first protocol layer being the SDAP layer or a protocol layer below the SDAP layer.
